(19) United States
(12) Patent Application Publication
(10) Pub. No.: US 2014/0194239 A1
(43) Pub. Date: Jul. 10, 2014

(54) HYBRID VEHICLE DRIVING DEVICE

(71) Applicants: Tomohito Ono, Gotenba-shi (JP); Yuji Iwase, Mishima-shi (JP); Yosuke Suzuki, Susono-shi (JP); Kensei Hata, Susono-shi (JP)

(72) Inventors: Tomohito Ono, Gotenba-shi (JP); Yuji Iwase, Mishima-shi (JP); Yosuke Suzuki, Susono-shi (JP); Kensei Hata, Susono-shi (JP)

(73) Assignee: TOYOTA JIDOSHA KABUSHIKI KAISHA, Toyota-shi, Aichi-ken (JP)

(21) Appl. No.: 14/237,839

(22) PCT Filed: Aug. 10, 2011
(86) PCT No.: PCT/JP2011/068331

§ 371 Date: Feb. 7, 2014

(51) Int. Cl. B60K 6/50

(52) U.S. Cl. CPC B60K 6/50; Y10S 903/911
USPC 475/5; 180/65.21; 903/911

(57) ABSTRACT

A hybrid vehicle driving device includes a first planetary gear mechanism, a second planetary gear mechanism, a clutch configured to connect and disconnect a carrier of the first planetary gear mechanism to and from a ring gear of the second planetary gear mechanism, and a brake configured to regulate a rotation of the ring gear of the second planetary gear mechanism by being engaged. The second planetary gear mechanism is of a double pinion type, a sun gear of the first planetary gear mechanism is connected to a first electric rotating machine, a carrier thereof is connected to an engine, and a ring gear thereof is connected to a driving wheel, respectively, and a sun gear of the second planetary gear mechanism is connected to a second electric rotating machine, and a carrier thereof is connected to the driving wheel, respectively.

### FIELD

The present invention relates to a hybrid vehicle driving device.

### BACKGROUND

Conventionally, hybrid vehicle driving devices have been known. For example, Patent Literature 1 and Patent Literature 2 disclose technologies of a power train capable of switching two modes i.e. an input split mode and a blended split mode.

### CITATION LIST

### Patent Literature

Patent Literature 1: Specification of U.S. Pat. No. 6,478,705
Patent Literature 2: Specification of U.S. Patent Application Publication No. 2008/0,053,723

### SUMMARY

### Technical Problem

There is still a room for improving the efficiency of a hybrid vehicle. For example, the improvement of transmission efficiency when a rotation is transmitted from an input side to an output side at a low speed reducing ratio in a hybrid vehicle driving device will be able to improve efficiency at the time of high speed travelling.

An object of the present invention is to provide a hybrid vehicle driving device capable of improving the efficiency of a hybrid vehicle.

### Solution to Problem

A hybrid vehicle driving device according to the present invention includes a first planetary gear mechanism; a second planetary gear mechanism; a clutch configured to connect and disconnect a carrier of the first planetary gear mechanism to and from a ring gear of the second planetary gear mechanism; and a brake configured to regulate a rotation of the ring gear of the second planetary gear mechanism by being engaged, wherein the second planetary gear mechanism is of a double pinion type, a sun gear of the first planetary gear mechanism is connected to a first electric rotating machine, a carrier thereof is connected to an engine, and a ring gear thereof is connected to a driving wheel, respectively, and a sun gear of the second planetary gear mechanism is connected to a second electric rotating machine, and a carrier thereof is connected to the driving wheel, respectively.

In the hybrid vehicle driving device, it is preferable that a traveling by a mode 2 is realized by engaging the clutch and the brake, respectively.

In the hybrid vehicle driving device, it is preferable that an order of disposition of respective rotating elements of the first planetary gear mechanism and the second planetary gear mechanism in an alignment chart at the time the clutch is engaged and the brake is released is in the order of the sun gear of the first planetary gear mechanism, the sun gear of the second planetary gear mechanism, the carrier of the first planetary gear mechanism and the ring gear of the second planetary gear mechanism, and the ring gear of the first planetary gear mechanism and the carrier of the second planetary gear mechanism.

In the hybrid vehicle driving device, it is preferable that in a hybrid traveling for causing a hybrid vehicle to travel using at least the engine as a power source, at least two modes of a mode 3 for releasing the clutch and engaging the brake, a mode 4 for engaging the clutch and releasing the brake, and a mode 5 for releasing the clutch and the brake can be selectively realized.

In the hybrid vehicle driving device, it is preferable that a traveling by a mode 1 is realized by releasing the clutch and engaging the brake.

In the hybrid vehicle driving device, it is preferable that the first electric rotating machine, the first planetary gear mechanism, the clutch, the second planetary gear mechanism, the second electric rotating machine, and the brake are sequentially disposed coaxially to a rotating shaft of the engine from the side near to the engine.

In the hybrid vehicle driving device, it is preferable that the first electric rotating machine, the first planetary gear mechanism, the second electric rotating machine, the second planetary gear mechanism, the clutch, and the brake are sequentially disposed coaxially to a rotating shaft of the engine from the side near to the engine.

In the hybrid vehicle driving device, it is preferable that the first electric rotating machine, the second electric rotating machine, the second planetary gear mechanism, the first planetary gear mechanism, the clutch, and the brake are sequentially disposed coaxially to a rotating shaft of the engine from side near to the engine.

In the hybrid vehicle driving device, it is preferable to further include a one way clutch configured to allow, when the rotating direction of the carrier of the second planetary gear mechanism at the time the hybrid vehicle travels forward is assumed a positive direction, the rotation of the ring gear of the second planetary gear mechanism in the positive direction, and regulate the rotation thereof in the direction opposite to the positive direction.

### Advantageous Effects of Invention

A hybrid vehicle driving device according to the present invention includes a first planetary gear mechanism, a second planetary gear mechanism, a clutch for connecting and disconnecting a carrier of the first planetary gear mechanism to and from a ring gear of the second planetary gear mechanism, and a brake for regulating the rotation of the ring gear of the second planetary gear mechanism by being engaged. The second planetary gear mechanism is of a double pinion type, and a sun gear of the first planetary gear mechanism is connected to a first electric rotating machine, a carrier thereof is connected to an engine, and a ring gear thereof is connected to a driving wheel, respectively, and a sun gear of the second planetary gear mechanism is connected to a second electric rotating machine, a carrier thereof is connected to the driving wheel, respectively. The hybrid vehicle driving device according to the present invention achieves an effect that it can configure a multi-mode and can realize improvement of efficiency by traveling in a mode suitable for a travelling state.

### BRIEF DESCRIPTION OF DRAWINGS

FIG. 1 is a skeleton view illustrating a main portion of a hybrid vehicle according to a first embodiment.

FIG. 2 is a view illustrating an engagement table of respective traveling modes of the first embodiment.

FIG. 3 is an alignment chart at the time of an EV-1 mode.

FIG. 4 is an alignment chart at the time of an EV-2 mode.

FIG. 5 is an alignment chart at the time of an EV-1 mode.

FIG. 6 is an alignment chart at the time of an HV-2 mode.

FIG. 7 is an alignment chart of four elements at the time of the HV-2 mode.

FIG. 8 is a view illustrating a theoretical transmission efficiency line according to the first embodiment.

FIG. 9 is a view illustrating an example of a vehicle drive apparatus using a second planetary gear mechanism configured as a single pinion type.

FIG. 10 is an alignment chart explaining an effect by a double pinion type second planetary gear mechanism.

FIG. 11 is a view of a theoretical transmission efficiency line explaining the effect by the double pinion type second planetary gear mechanism.

FIG. 12 is a skeleton view illustrating a main portion of a hybrid vehicle according to a first modification.

FIG. 13 is a skeleton view illustrating a main portion of a hybrid vehicle according to a second modification.

FIG. 14 is a skeleton view illustrating a main portion of the hybrid vehicle according to the second embodiment.

FIG. 15 is another skeleton view illustrating a main portion of the hybrid vehicle according to the second embodiment.

FIG. 16 is still another skeleton view illustrating a main portion of the hybrid vehicle according to the second embodiment.

### DESCRIPTION OF EMBODIMENTS

A hybrid vehicle driving device according to an embodiment of the present invention will be explained below in detail referring to the drawings. The present invention is not limited by the embodiments. Some of the components of the embodiment include components that can be easily devised by a person skilled in the art or substantially the same components.

### First Embodiment

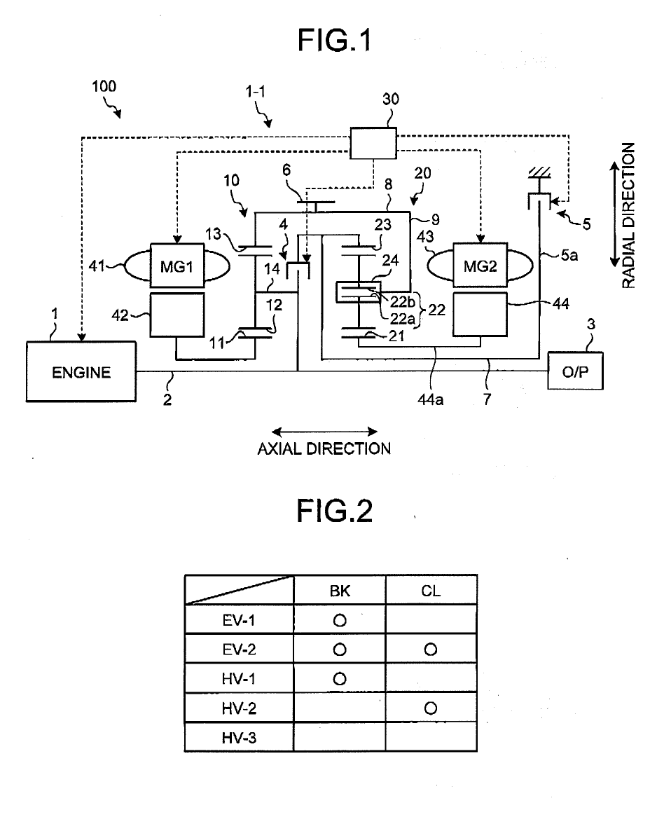

A first embodiment will be explained referring to FIG. 1 to FIG. 11. The embodiment relates to a hybrid vehicle driving device. FIG. 1 is a skeleton view illustrating a main portion of the hybrid vehicle according to the first embodiment and FIG. 2 is a view illustrating an engagement table of respective traveling modes of the first embodiment.

As illustrated in FIG. 1, a hybrid vehicle 100 includes an engine 1, a first electric rotating machine MG1, a second electric rotating machine MG2, an oil pump 3, and a hybrid vehicle driving device 1-1. The hybrid vehicle driving device 1-1 of the embodiment includes a first planetary gear mechanism 10, a second planetary gear mechanism 20, a clutch 4, and a brake 5. The clutch 4 is a clutch device for connecting and disconnecting a first carrier 14 that is a carrier of the first planetary gear mechanism 10 to and from a second ring gear 23 that is a ring gear of the second planetary gear mechanism 20. The brake 5 can regulate the rotation of the second ring gear 23 by being engaged.

A first sun gear 11 that is a sure gear of the first planetary gear mechanism 10 is connected to the first electric rotating machine MG1, the first carrier 14 is connected to the engine 1, and a first ring gear 13 that is a ring gear of the first planetary gear mechanism 10 is connected to a driving wheel of the hybrid vehicle 100. Further, a second sun gear 21 that is a sun gear of the second planetary gear mechanism 20 is connected to the second electric rotating machine MG2, and a second carrier 24 that is a carrier of the second planetary gear mechanism 20 is connected to the driving wheel of the hybrid vehicle 100. The first ring gear 13 and the second carrier 24 may not be directly connected to the driving wheel and may be connected to the driving wheel via, for example, a differential mechanism and an output shaft.

The engine 1 converts the combustion energy of fuel to a rotary motion and outputs the rotary motion to a rotating shaft 2. The rotating shaft 2 extends in, for example, the vehicle width direction of the hybrid vehicle 100. It is assumed in the specification that “axial direction” means the axial direction of the rotating shaft 2 unless otherwise noted particularly. The oil pump 3 is disposed to the end of the side opposite to the engine side in the rotating shaft 2. The oil pump 3 is driven by the rotation of the rotating shaft 2 and ejects a lubricating oil. The lubricating oil ejected by the oil pump 3 is supplied to respective sections such as the first electric rotating machine MG1, the second electric rotating machine MG2, the first planetary gear mechanism 10, the second planetary gear mechanism 20, and the like.

The first electric rotating machine MG1 and the second electric rotating machine MG2 have a function as a motor (an electric motor) and a function as a generator, respectively. The first electric rotating machine MG1 and the second electric rotating machine MG2 are connected to a battery via an inverter. The first electric rotating machine MG1 and the second electric rotating machine MG2 can convert the electric power supplied from the battery to a mechanical power and output the mechanical power and further can convert a mechanical power to an electric power by being driven by the power input thereto. The electric power generated by the electric rotating machines MG1 and MG2 can be stored in the battery. An alternating-current synchronous motor generator, for example, can be used as the first electric rotating machine MG1 and the second electric rotating machine MG2.

The first electric rotating machine MG1 has a stator 41 and a rotor 42. The rotor 42 is disposed coaxially to the first sun gear 11, is connected to the first sun gear 11, and rotates integrally with the first sun gear 11. The second electric rotating machine MG2 has a stator 43 and a rotor 44. The rotor 44 is disposed coaxially to the second sun gear 21. A rotating shaft 44a of the rotor 44 is connected to the second sun gear 21 and the rotor 44 rotates integrally with the second sun gear 21. The rotating shaft 44a is disposed externally of the rotating shaft 2 of the engine 1 in a radial direction and supported so as to be free to relatively rotate to the rotating shaft 2.

A coupling shaft 7 is disposed between the rotating shaft 44a of the rotor 44 and the rotating shaft 2 of the engine 1. The coupling shaft 7 connects the second ring gear 23 to a rotary member 5a of the brake 5. The coupling shaft 7 is supported so as to be free to rotate to each of the rotating shaft 44a of the rotor 44 and the rotating shaft 2 of the engine 1. The brake 5 can regulate the rotation of the second ring gear 23 by regulating the rotation of the rotary member 5a by being engaged.

The first planetary gear mechanism 10 and the second planetary gear mechanism 20 are disposed coaxially to the rotating shaft 2, respectively and confront each other in the axial direction. The first planetary gear mechanism 10 is disposed nearer to the engine side than the second planetary gear mechanism 20 in the axial direction. The first electric rotating machine MG1 is disposed nearer to the engine side than the first planetary gear mechanism 10 in the axial direction, and the second electric rotating machine MG2 is disposed nearer to the side opposite to the engine side than the second planetary gear mechanism 20 in the axial direction. Specifically, the first electric rotating machine MG1 confronts the second electric rotating machine MG2 in the axial direction across the first planetary gear mechanism 10 and the second planetary gear mechanism 20. The first electric rotating machine MG1, the first planetary gear mechanism 10, the clutch 4, the second planetary gear mechanism 20, the second electric rotating machine MG2, and the brake 5 are sequentially disposed coaxially to the rotating shaft 2 of the engine 1 from the side nearer to the engine 1.

The first planetary gear mechanism 10 is of a single pinion type and has the first sun gear 11, a first pinion gear 12, the first ring gear 13, and the first carrier 14. The first ring gear 13 is disposed coaxially to the first sun gear 11 externally of the first sun gear 11 in the radial direction. The first pinion gear 12 is disposed between the first sun gear 11 and the first ring gear 13 and meshed with the first sun gear 11 and the first ring gear 13, respectively. The first pinion gear 12 is supported by the first carrier 14 so as to be free to rotate. The first carrier 14 is coupled with the rotating shaft 2 and rotates integrally with the rotating shaft 2. Thus, the first pinion gear 12 can rotate (revolve) around the central axis line of the rotating shaft 2 of the engine 1 together with the rotating shaft 2 thereof and further can rotate around the central axis line of the first pinion gear 12 (rotate on its axis) by being supported by the first carrier 14.

The second planetary gear mechanism 20 is of a double pinion type and has the second sun gear 21, a second pinion gear 22, the second ring gear 23 and the second carrier 24. The second ring gear 23 is disposed coaxially to the second sun gear 21 externally of the second sun gear 21 in the radial direction. The second pinion gear 22 has a second inside pinion gear 22a and a second outside pinion gear 22b. The second pinion gear 22 is disposed between the second sun gear 21 and the second ring gear 23. The second inside pinion gear 22a is disposed internally of the second outside pinion gear 22b in the radial direction and meshed with the second sun gear 21 and the second outside pinion gear 22b, respectively. The second outside pinion gear 22b is meshed with the second inside pinion gear 22a and the second ring gear 23, respectively. The second inside pinion gear 22a and the second outside pinion gear 22b are supported by the second carrier 24, respectively so as to be free to rotate.

The second ring gear 23 is connected to the first carrier 14 via the clutch 4. The clutch 4 connects and disconnects the first carrier 14 to and from the second ring gear 23. The clutch 4 regulates the relative rotation between the first carrier 14 and the second ring gear 23 by being engaged so as to integrally rotate the first carrier 14 and the second ring gear 23. In contrast, releasing the clutch 4 disconnects the first carrier 14 from the second ring gear 23 so that the first carrier 14 and the second ring gear 23 can rotate independently of each other.

The brake 5 can regulate the rotation of the second ring gear 23. Engaging the rotary member 5a (engaging element) on the second ring gear 23 side with an engaging element on the vehicle body side causes the brake 5 to regulate the rotation of the second ring gear 23 so as to be able to stop the rotation of the second ring gear 23. In contrast, releasing the brake 5 can allow the rotation of the second ring gear 23.

Although the clutch 4 and the brake 5 can be configured as, for example, a dog teeth mesh type, they are not limited thereto and may be configured as a friction engagement type. An actuator that is driven by an electromagnetic force and a hydraulic pressure, and other known actuator can be used as an actuator for driving the clutch 4 and as an actuator for driving the brake 5. The dog teeth mesh type has a dragging loss smaller than the friction engagement type employing a wet friction material at the time of disengagement, by which efficiency can be improved. Using the electromagnetic type as a dog teeth actuator makes a hydraulic pressure circuit for the clutch 4 and the brake 5 unnecessary, which can simplify a T/A and reduce the weight thereof. When a hydraulic pressure actuator is employed, an electric oil pump may be used as a hydraulic pressure source.

The clutch 4 and the brake 5 may be released by the driving force of an actuator against the urging force of a return spring and the like or may be engaged by the driving force of an actuator against the urging force.

The first ring gear 13 is coupled with the second carrier 24 so as to be free to rotate integrally. In the embodiment, the first ring gear 13 is an internal gear formed on the inner peripheral surface of a cylindrical rotary member 8. The rotary member 8 is supported coaxially to the rotating shaft 2 so as to be free to rotate. A flange section 9 is connected to the end of the side opposite to the engine side in the rotary member 8. The flange section 9 projects internally of the rotary member 8 in the radial direction. The inside end of the flange section 9 in the radial direction is connected to the second carrier 24. Specifically, the second carrier 24 is supported so as to be free to rotate via the flange section 9 and the rotary member 8. Thus, the second pinion gear 22 can rotate (revolve) around the central axis line of the rotating shaft 2 together with the second carrier 24. The second inside pinion gear 22a and the second outside pinion gear 22b can rotate (revolve) around the central axis lines thereof by being supported by the second carrier′ 24.

An output gear 6 is formed on the outer peripheral surface of the rotary member 8. The output gear 6 is coupled with an output shaft of the hybrid vehicle 100 via a differential mechanism and the like. The output gear 6 is an output section for outputting the power transmitted from the engine 1 and the electric rotating machines MG1 and MG2 via the planetary gear mechanisms 10, 20 to the driving wheel. The power transmitted from the engine 1, the first electric rotating machine MG1, and the second electric rotating machine MG2 to the output gear 6 is transmitted to the driving wheel of the hybrid vehicle 100 via the output shaft. Further, the power input from a road surface to the driving wheel is transmitted from the output gear 6 to the hybrid vehicle driving device 1-1 via the output shaft.

An ECU 30 is an electronic control unit having a computer. The ECU 30 is connected to the engine 1, the first electric rotating machine MG1, and the second electric rotating machine MG2, respectively and can control the engine 1, and the electric rotating machines MG1 and MG2. Further, the ECU 30 can control the release and engagement of the clutch 4 and the brake 5. When an electric oil pump is provided as a hydraulic pressure source of the clutch 4 and the brake 5, the ECU 30 can control the electric oil pump.

The hybrid vehicle 100 can selectively carry out hybrid travel or EV travel. The hybrid travel is a traveling mode for causing the hybrid vehicle 100 to travel using at least one of the engine 1 of the engine 1, the first electric rotating machine MG1 and the second electric rotating machine MG2 as a power source. The hybrid travel may further use at least one of the first electric rotating machine MG1 or the second electric rotating machine MG2 as the power source in addition to the engine 1 or use one of the first electric rotating machine MG1 or the second electric rotating machine MG2 as the power source and causes the other thereof to function as a reaction force receiver of the engine 1. In addition to the above-mentioned, the first electric rotating machine MG1 and the second electric rotating machine MG2 may appropriately function as the motor or the generator according to the modes described later and can also rotate idly in a no-load state.

The EV travel is a traveling mode for traveling by stopping the engine 1 and using at least any one of the first electric rotating machine MG1 and the second electric rotating machine MG2 as the power source. In the EV travel, at least any one of the first electric rotating machine MG1 and the second electric rotating machine MG2 may be caused to generate power according to a traveling state and a battery charge state and at least any one of the first electric rotating machine MG1 and the second electric rotating machine MG2 may be caused to rotate idly.

As illustrated in FIG. 2, the hybrid vehicle driving device 1-1 of the embodiment can realize five modes according to a combination of the engagement and the release of the clutch 4 and the brake 5. In FIG. 2, the circular marks of Column BK illustrate the engagement of the brake 5 and Column BK without mark illustrates the release of the brake 5. Further, the circular marks of Column CL illustrate the engagement of the clutch 4 and Column CL without mark illustrates the release of the clutch 4.

EV-1 Mode

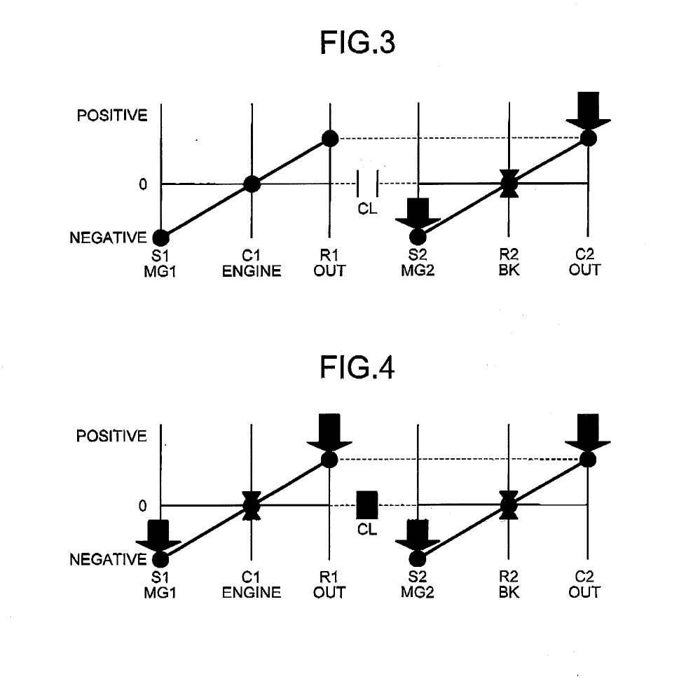

When the brake 5 is engaged and the clutch 4 is released, a mode 1 (a traveling mode 1) is realized, and traveling by the mode 1 becomes possible. In the embodiment, the following EV-1 mode corresponds to the mode 1. The EV-1 mode is an EV traveling mode for carrying out traveling by stopping the engine 1 and using the second electric rotating machine MG2 as the power source. The EV-1 mode can carry out EV traveling similar to the EV traveling in a vehicle on which so-called THS (Toyota Hybrid System) is mounted. FIG. 3 is an alignment chart at the time of the EV-1 mode. In the respective alignment charts including FIG. 3, S1 illustrates the first sun gear 11, C1 illustrates the first carrier 14, R1 illustrates the first ring gear 13, S2 illustrates the second sun gear 21, C2 illustrates the second carrier 24, and R2 illustrates the second ring gear 23. Further, CL illustrates the clutch 4, BK illustrates the brake 5, and OUT illustrates the output gear 6. It is assumed that the rotating direction of the first ring gear 13 and the second carrier 24 when the hybrid vehicle 100 travels forward is a positive direction and torque in the positive rotating direction (an upward arrow in the figure) is positive torque.

As illustrated in FIG. 3, in the EV-1 mode, since the clutch 4 is released, the first carrier 14 (C1) and the second ring gear 23 (R2) can relatively rotate, and since the brake 5 is engaged, the rotation of the second ring gear 23 is regulated. In the second planetary gear mechanism 20, the rotating direction of the second sun gear 21 becomes opposite to the rotating direction of the second carrier 24. When the second electric rotating machine MG2 generates negative torque and rotates in a negative direction, the output gear 6 rotates in the positive direction by the power of the second electric rotating machine MG2. With the operation, the hybrid vehicle 100 can be caused to travel forward. In the first planetary gear mechanism 10, the first carrier 14 stops and the first sun gear 11 rotates idly in the negative direction. In the EV-1 mode, when regeneration is not allowed because a battery is in a full charge state, and the like, deceleration can be applied to the hybrid vehicle 100 as a large amount of inertia by idly rotating the second electric rotating machine MG2.

EV-2 Mode

A mode 2 (traveling mode 2) is realized when the brake 5 and the clutch 4 are engaged, respectively and traveling by the mode 2 becomes possible. In the embodiment, the following EV-2 mode corresponds to the mode 2. The EV-2 mode is an EV traveling mode for stopping the engine 1 and causing the hybrid vehicle 100 to travel using at least any one of the first electric rotating machine MG1 and the second electric rotating machine MG2 as the power source. FIG. 4 is an alignment chart at the time of the EV-2 mode. In the EV-2 mode, engaging the brake 5 and engaging the clutch 4 regulates the rotation of the first carrier 14 and the rotation of the second ring gear 23, respectively. Thus, in the first planetary gear mechanism 10, the rotating direction of the first sun gear 11 becomes opposite to the rotating direction of the first ring gear 13. The first electric rotating machine MG1 generates negative torque and rotates negatively, thereby rotating the output gear 6 positively so that the hybrid vehicle 100 can be caused to travel forward. Further, in the second planetary gear mechanism 20, the rotating direction of the second sun gear 21 becomes opposite to the rotating direction of the second carrier 24. The second electric rotating machine MG2 generates negative torque and rotates negatively, thereby capable of causing the hybrid vehicle 100 to travel forward.

In the EV-2 mode, the hybrid vehicle 100 can be caused to travel using the two electric rotating machines i.e. the first electric rotating machine MG1 and the second electric rotating machine MG2 as the power source. Further, in the EV-2 mode, at least any one of the first electric rotating machine MG1 and the second electric rotating machine MG2 can be caused to appropriately generate power. Since one of the electric rotating machines can generate (or regenerate) torque or both the electric rotating machines can share the generation of torque, it becomes possible to cause the respective electric rotating machines to operate at an efficient operation point and to ease a restriction such as a torque limitation due to heat. Fuel economy can be improved by, for example, preferentially causing an electric rotating machine, which can output torque efficiently, of the electric rotating machines MG1 and MG2 to output (or to regenerate) torque according to a travel speed. Further, when torque is restricted due to heat in any one of the electric rotating machines, target torque can be satisfied by assisting the electric rotating machine by the output (or the regeneration) of the other electric rotating machine.

In the EV-2 mode, at least any one of the first electric rotating machine MG1 and the second electric rotating machine MG2 can be also idly rotated. When, for example, the regeneration is not allowed because the battery is in the full charge state and the like, deceleration can be applied to the hybrid vehicle 100 as a large amount of inertia by idly rotating the first electric rotating machine MG1 and the second electric rotating machine MG2 at the same time.

According to the EV-2 mode, it becomes possible to carry out the EV travel in wide travel conditions and to carry out the EV travel continuously for a long time. Thus, the EV-2 mode is suitable for a hybrid vehicle such as a plug-in hybrid vehicle and the like which carries out the EV traveling frequently.

HV-1 Mode

When the brake 5 is engaged and the clutch 4 is released, a mode 3 (a traveling mode 3) is realized and traveling by the mode 3 becomes possible. In the embodiment, the following HV-1 mode corresponds to the mode 3. In the HV-1 mode, hybrid traveling similar to the hybrid traveling of the vehicle mounted with THS can be carried out.

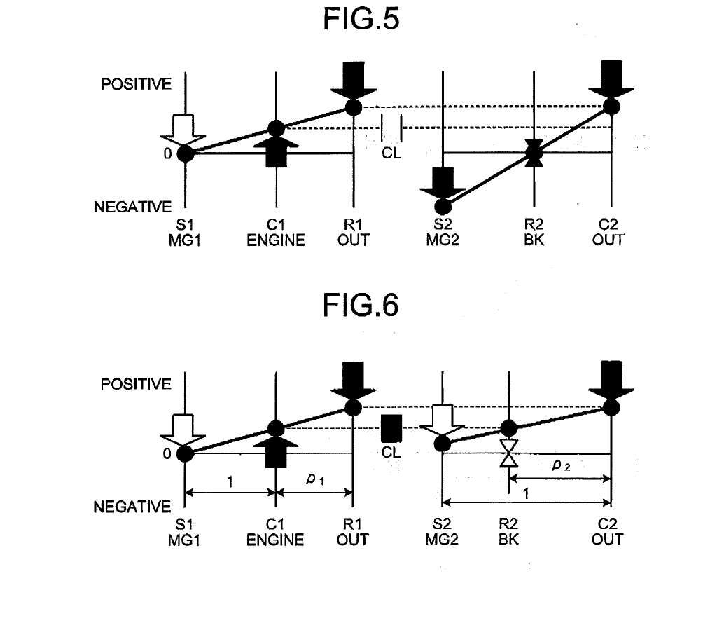

FIG. 5 is an alignment chart at the time of the HV-1 mode. At the time of the HV-1 mode, the engine 1 is driven and the output gear 6 is rotated by the power of the engine 1. In the first planetary gear mechanism 10, the first electric rotating machine MG1 generates negative torque and takes a reaction force, which allows to transmit power from the engine 1 to the output gear 6. In the second planetary gear mechanism 20, the brake 5 is engaged and the rotation of the second ring gear 23 is regulated, which makes the rotating direction of the second sun gear 21 opposite to the rotating direction of the second carrier 24. The second electric rotating machine MG2 can generate a driving force in a forward travel direction to the hybrid vehicle 100 by generating negative torque.

In the hybrid vehicle driving device 1-1 of the embodiment, in the alignment chart, the first ring gear 13 on the output side is positioned on an over drive side that is opposite to the first electric rotating machine MG1 that takes the reaction force across the engine 1. Thus, the rotation of the engine 1 is increased and transmitted to the output gear 6.

HV-2 Mode

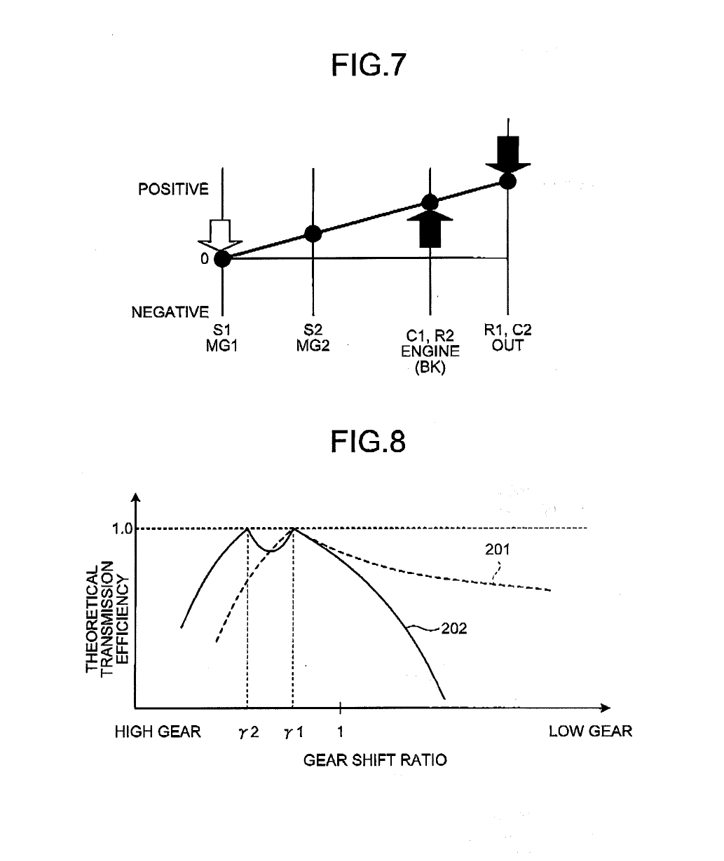

When the brake 5 is released and the clutch 4 is engaged, a mode 4 (a traveling mode 4) is realized, and traveling by the mode 4 becomes possible. In the embodiment, the following RV-2 mode (the composite split mode) corresponds to the mode 4. The HV-2 mode is the composite split mode in which the first electric rotating machine MG1, the second electric rotating machine MG2, the engine 1, and the output gear 6 are coupled with a four element planetary in this order. As explained below referring to FIG. 6 to FIG. 8, the HV-2 mode becomes a system having a mechanical point on the high gear side to the HV-1 mode and has an advantage that transmission efficiency is improved in a high gear operation. The mechanical point is a machine transmission point and is a high efficiency operation point with an electric path of zero. FIG. 6 is an alignment chart at the time of the HV-2 mode, FIG. 7 is an alignment chart of four elements at the time of the HV-2 mode, and FIG. 8 is a view illustrating a theoretical transmission efficiency line according to the first embodiment.

In the HV-2 mode, the first ring gear 13 and the second carrier 24 operate as a rotation element in which they rotate integrally, and the first carrier 14 and the second ring gear 23 operate as a rotation element in which they rotate integrally. Thus, the first planetary gear mechanism 10 and the second planetary gear mechanism 20 function as the four-element planetary in their entirety.

An alignment chart of the four-element planetary composed of the first planetary gear mechanism 10 and the second planetary gear mechanism 20 is as illustrated in FIG. 7. In the embodiment, the order of disposition of respective rotating elements of the first planetary gear mechanism 10 and the second planetary gear mechanism 20 in the alignment chart is in the order of the first sun gear 11, the second sun gear 21, the first carrier 14 and the second ring gear 23, and the first ring gear 13 and the second carrier 24. The gear shift ratio of the first planetary gear mechanism 10 and the gear shift ratio of the second planetary gear mechanism 20 are determined so that the order of disposition of the first sun gear 11 and the second sun gear 21 becomes the above order of disposition on the alignment chart. Specifically, referring to FIG. 6, in the respective planetary gear mechanisms 10 and 20, the gear shift ratios ρ1 and ρ2 between the carriers 14 and 24 and ring gears 13 and 23 when the gear shift ratio between the sun gears 11 and 21 and the carriers 14 and 24 is set to 1 is such that the gear shift ratio ρ2 of the second planetary gear mechanism 20 is larger than the gear shift ratio ρ1 of the first planetary gear mechanism 10.

In the HV-2 mode, the clutch 4 is engaged, thereby coupling the first carrier 14 with the second ring gear 23. Thus, any of the first electric rotating machine MG1 and the second electric rotating machine MG2 can receive the reaction force to the power output by the engine 1. Since one of or both the first electric rotating machine MG1 and the second electric rotating machine MG2 can receive the reaction force of the engine 1 while sharing the reception of torque, which makes it possible to carry out an operation at the efficient operation point or to ease the restriction such as the torque limitation and the like due to heat. As a result, the efficiency of the hybrid vehicle 100 can be improved.

For example, the preferential reception of the reaction force by the electric rotating machine, which can operate efficiently, of the first electric rotating machine MG1 and the second electric rotating machine MG2 can improve the efficiency. As an example, when the engine rotates at a low rotation number at a high speed, there is thought a case that the rotation number of the first electric rotating machine MG1 becomes a negative rotation number. In the case, the reception of the reaction force of the engine 1 by the first electric rotating machine MG1 results in a reverse power running state in which electric power is consumed and negative torque is generated, which deteriorates efficiency.

As can be understood from FIG. 7, in the hybrid vehicle driving device 1-1 of in the embodiment, the second electric rotating machine MG2 more unlikely rotates negatively than the first electric rotating machine MG1 and can more likely receive the reaction force in a positive rotation state. Thus, preferentially causing the second electric rotating machine MG2 to receive the reaction force when the first electric rotating machine MG1 rotates negatively can suppress the deterioration of efficiency due to reverse power running and can improve the fuel economy by improving the efficiency.

When torque is limited due to heat in any one of the electric rotating machines, a necessary reaction force can be satisfied by assisting the electric rotating machine by the regeneration (or the output) of the other electric rotating machine.

As explained referring to FIG. 8, since the HV-2 mode has the mechanical point on the high gear side, it has an advantage that the transmission efficiency is improved in the high gear operation. In FIG. 8, a horizontal axis illustrates a gear shift ratio, and a vertical axis illustrates theoretical transmission efficiency. The gear shift ratio is the ratio (the speed reducing ratio) of the input side rotation number to the output side rotation number of the planetary gear mechanisms 10 and 20 and illustrates, for example, the rotation number of the first carrier 14 to the rotation number of the first ring gear 13 and the second carrier 24. In the horizontal axis, a-left side is the high gear side where the gear shift ratio is small and a right side is a low gear side where the gear shift ratio is large. The theoretical transmission efficiency achieves a maximum efficiency of 1.0 when the power input to the planetary gear mechanisms 10 and 20 is entirely transmitted to the output gear 6 by a mechanical transmission without via an electric path.

In FIG. 8, a broken line 201 illustrates a transmission efficiency line in the HV-1 mode, and a solid line 202 illustrates a transmission efficiency line in the HV-2 mode. The transmission efficiency line 201 in the HV-1 mode achieves maximum efficiency at a gear shift ratio γ1. At the gear shift ratio γ1, since the rotation number of the first electric rotating machine MG1 (the first sun gear 11) becomes 0, the electric path due to the reception of the reaction force becomes 0. Thus, an operation point becomes such that power can be transmitted from the engine 1 or the second electric rotating machine MG2 to the output gear 6 only by a mechanical power transmission. The gear shift ratio γ1 is a gear shift ratio on an over drive side i.e. a gear shift ratio smaller than 1. In the specification, the gear shift ratio γ1 will be described also as “a first machine transmission gear shift ratio γ1”. An approach of the gear shift ratio nearer to a value on the low gear side than the first machine transmission gear shift ratio γ1 gradually reduces the transmission efficiency in the HV-1 mode. Further, an approach of the gear shift ratio to a value nearer to the high gear side than the first machine transmission gear shift ratio γ1 greatly reduces the transmission efficiency in the EV-1 mode.

The transmission efficiency line 202 in the RV-2 mode has the mechanical point at the gear shift ratio γ2 in addition to the gear shift ratio γ1. This is because, in the alignment chart of the four elements (FIG. 7), the gear shift ratios of the planetary gear mechanisms 10 and 20 are determined so that the first electric rotating machine MG1 and the second electric rotating machine MG2 are located at a different position on the horizontal axis. In the HV-2 mode, the rotation number of the first electric rotating machine MG1 becomes 0 at the first machine transmission gear shift ratio γ1 and the reaction force is received by the first electric rotating machine MG1 in the state so that the mechanical point can be realized. Further, the rotation number of the second electric rotating machine MG2 becomes 0 at the gear shift ratio γ2 and the reaction force is received by the first electric rotating machine MG1 in the state so that the mechanical point can be realized. The gear shift ratio γ2 will be described also as “a second machine transmission gear shift ratio γ2”.

The transmission efficiency in the HV-2 mode is greatly reduced than the transmission efficiency in the HV-1 mode according to an increase of the gear shift ratio in the region nearer to the low gear side than the first machine transmission gear shift ratio γ1. Further, the transmission efficiency line 202 in the HV-2 mode curves to a low efficiency side in the region of the gear shift ratio between the first machine transmission gear shift ratio γ1 and the second machine transmission gear shift ratio γ2. In the region, the transmission efficiency in the HV-2 mode is equal to or higher than the transmission efficiency in the HV-1 mode. Although the transmission efficiency in the HV-2 mode is reduced as the gear shift ratio reduces in the region nearer to the high gear side than the second machine transmission gear shift ratio γ2, the transmission efficiency is relative higher efficiency than the transmission efficiency in the HV-1 mode.

As described above, since the HV-2 mode has the mechanical point to the second machine transmission gear shift ratio γ2 nearer to the high gear side than the first machine transmission gear shift ratio γ1 in addition to the first machine transmission gear shift ratio γ1, the transmission efficiency can be improved in the high gear operation. As a result, the fuel economy can be improved by the improvement of the transmission efficiency at the time of high speed travelling.

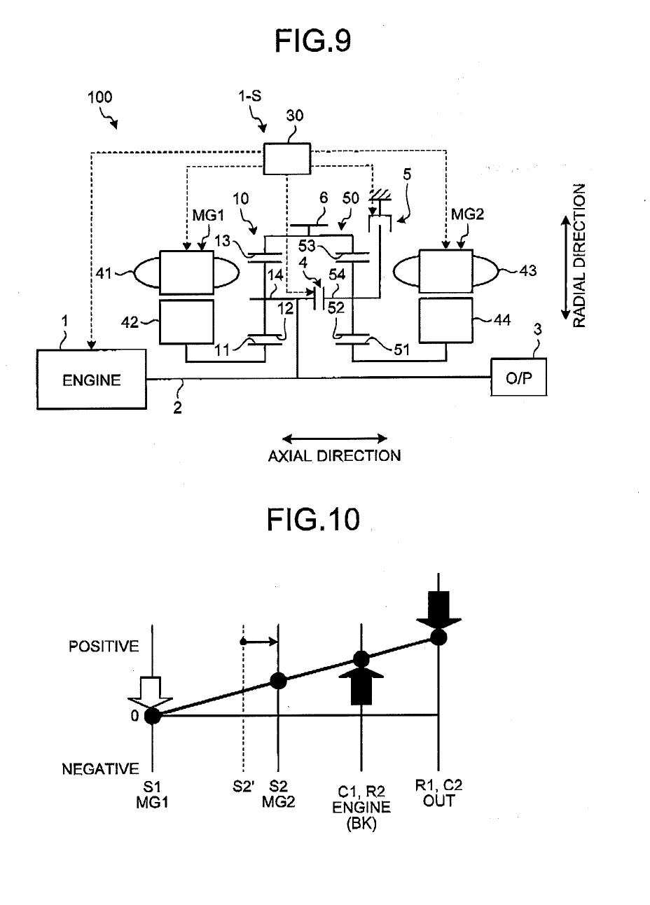

Since the second planetary gear mechanism 20 is configured as the double pinion type, the hybrid vehicle driving device 1-1 of the embodiment can take a larger gear shift ratio than when it is configured as the single pinion type. Specifically, (the number of teeth of the second sun gear 21)/(the number of teeth of the second ring gear 23) of the second planetary gear mechanism 20 can be made larger when the double pinion type is employed than when the single pinion type is employed. As a result, as will be explained referring to FIG. 9 to FIG. 11, in the hybrid vehicle driving device 1-1 of the embodiment, the highest efficiency point in the HV-2 mode can be set nearer to the high gear side.

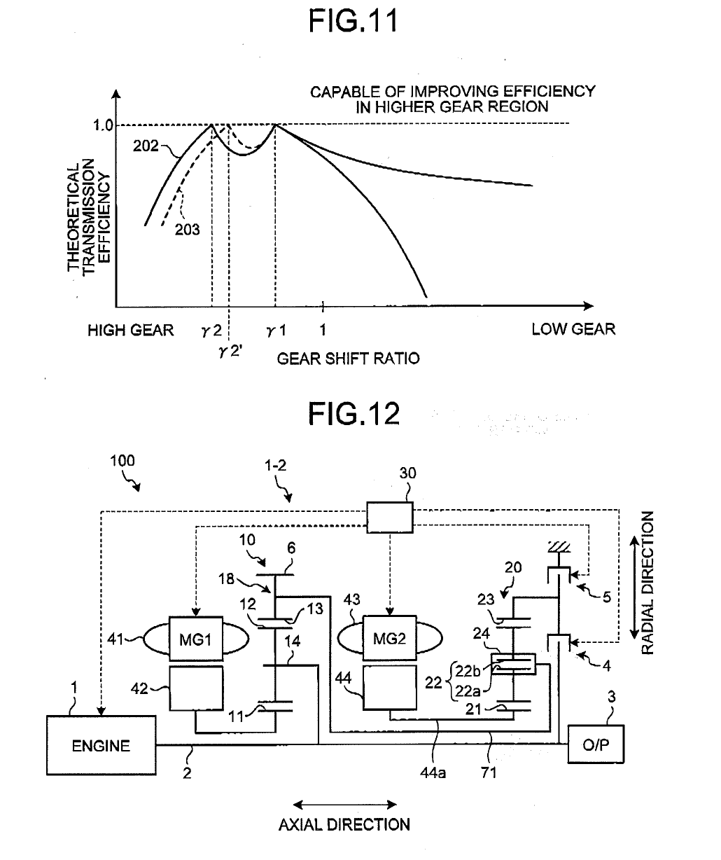

FIG. 9 is a view illustrating an example of a vehicle driving device when the second planetary gear mechanism 20 is configured as the single pinion type, FIG. 10 is an alignment chart explaining an effect by the second planetary gear mechanism 20 configured as the double pinion type, and FIG. 11 is a view of a theoretical transmission efficiency line explaining an effect by the second planetary gear mechanism 20 configured as the double pinion type. In a vehicle driving device 1-S illustrated in FIG. 9, a second planetary gear mechanism 50 is configured as the single pinion type. Likewise the hybrid vehicle driving device 1-1 of the embodiment, a second sun gear 51 is connected to a second electric rotating machine MG2. A second pinion gear 52 is meshed with the second sun gear 51 and a second ring gear 53, respectively.

In contrast, different from the hybrid vehicle driving device 1-1 of the embodiment, a clutch 4 connects and disconnects a first carrier 14 to and from a second carrier 54. A brake 5 regulates the rotation of the second carrier 54 by being engaged. Further, a first ring gear 13 and the second ring gear 53 are connected to the driving wheel of the hybrid vehicle 100.

In FIG. 10, a symbol S2′ illustrates the position of the second sun gear 51 of the vehicle driving device 1-S on the alignment chart. Since the second planetary gear mechanism 20 is configured as the double pinion type, the hybrid vehicle driving device 1-1 of the embodiment can set the position (S2) of a second sun gear 21 on alignment chart to a position nearer to the engine than the position (S2′) in the case of the single pinion type. This corresponds to that the gear shift ratio of the second planetary gear mechanism 20 can be made larger than the gear shift ratio of the second planetary gear mechanism 50.

In the vehicle driving device 1-S, switching the clutch 4 and the brake 5 can realize the respective modes illustrated in FIG. 2. For example, engaging the clutch 4 and releasing the brake 5 can realize the HV-2 mode.

As illustrated in FIG. 11, the hybrid vehicle driving device 1-1 of the embodiment can set the highest efficiency point in the HV-2 mode nearer to the high gear side. In FIG. 11, reference numeral 203 illustrates the transmission efficiency line in the HV-2 mode of the vehicle driving device 1-S. The second machine transmission gear shift ratio γ2 of the hybrid vehicle driving device 1-1 of the embodiment is a gear shift ratio nearer to the high gear side than a second machine transmission gear shift ratio γ2′ of the vehicle driving device 1-S. With the configuration, the hybrid vehicle driving device 1-1 can set the highest efficiency point nearer to the high gear side than the vehicle driving device 1-S employing the single pinion type and can make a high gear region more efficient. Thus, the hybrid vehicle driving device 1-1 can increase a loss reduction effect at the time of high speed travelling.

The hybrid vehicle driving device 1-1 of the embodiment appropriately switches the HV-1 mode and the HV-2 mode at the time of hybrid travelling, thereby capable of improving the transmission efficiency. For example, selecting the HV-1 mode in the region of the gear shift ratio nearer to the low gear side than the first machine transmission gear shift ratio γ1 and selecting the HV-2 mode in the region of the gear shift ratio nearer to the high gear side than the first machine transmission gear shift ratio γ1 can improve the transmission efficiency in the region of a wide gear shift ratio from a low gear region to a high gear region.

HV-3 Mode

Releasing the clutch 4 and the brake 5 realizes a mode 5 (traveling mode 5) and traveling by the mode 5 becomes possible. In the embodiment, the following HV-3 mode corresponds to the mode 5. The HV-3 mode is a traveling mode in which travelling can be carried out by the engine 1 and the first electric rotating machine MG1 by isolating the second electric rotating machine MG2. In the HV-1 mode, since the brake 5 is engaged, the Second electric rotating machine MG2 rotates at all times in association with the rotation of the second carrier 24 at the time of traveling. At a high rotation number, the second electric rotating machine MG2 cannot output large torque and the rotation of the second carrier 24 is increased and transmitted to the second sun gear 21. From a viewpoint of improving efficiency, it is not necessarily preferable to rotate the second electric rotating machine MG2 at all times at the time of high speed travelling.

In the HV-3 mode, since the brake 5 is released and the clutch 4 is also released, it is possible to isolate the second electric rotating machine MG2 from a power transmission path and to stop it. In the HV-3 mode, isolating the second electric rotating machine MG2 from the wheel at the time of high speed travelling can reduce a drag loss of the second electric rotating machine MG2 when it is not necessary and further can eliminate a restriction to the highest vehicle speed due to the highest allowable rotation number to the second electric rotating machine MG2.

In the hybrid travelling, the hybrid vehicle driving device 1-1 of the embodiment can selectively realize the three modes i.e. the HV-1 mode, the HV-2 mode, and the HV-3 mode by the combination of engagement and release of the clutch 4 and the brake 5. For example, in the region of the highest speed reducing ratio, the HV-1 mode may be selected, in the region of the lowest speed reducing ratio, the HV-3 mode may be selected, and, in the region of an intermediate speed reducing ratio, the HV-2 mode may be selected. Any two modes of the three HV modes may be selectively realized. For example, at a low speed reducing ratio, any of the HV-2 mode or the HV-3 mode may be selected, and, at the highest speed reducing ratio, the HV-1 mode may be selected.

As explained above, the hybrid vehicle, driving device 1-1 of the embodiment has the two planetary gear mechanisms 10, 20, the two electric rotating machines MG1 and MG2, the brake 5, and the clutch 4 and can configure plural modes (a THS mode, a composite split mode, and a high vehicle speed mode) at the time of hybrid and two EV traveling modes having a different number of drive electric rotating machines by engaging and disengaging the brake 5 and the clutch 4. Since the hybrid vehicle driving device 1-1 of the embodiment can configure a multimode by a small number of engaging elements, it can achieve the improvement of efficiency in traveling in a mode suitable for a travelling state and the reduction of the number of components and cost at the same time.

The hybrid vehicle driving device 1-1 of the embodiment is likely applied to the hybrid vehicle 100 having an FF structure to which a multi-axis configuration is indispensable because the output shaft is connected to an outermost diameter. In the respective planetary gear mechanisms 10 and 20, since the sections that carry out the highest rotation are the sun gears 11 and 21 near to the centers of rotation, the configuration can suppress a centrifugal force and is advantageous in terms of strength.

### First Modification of First Embodiment

A first modification of the first embodiment will be explained. FIG. 12 is a skeleton view illustrating a main portion of a hybrid vehicle according to the first modification. A hybrid vehicle driving device 1-2 of the modification is different from the hybrid vehicle driving device 1-1 of the first embodiment in that a second planetary gear mechanism 20 and a clutch 4 are disposed to the side opposite to a first planetary gear mechanism 10 across a second electric rotating machine MG2. A first electric rotating machine MG1, the first planetary gear mechanism 10 and an output gear 6, and the second electric rotating machine MG2, the second planetary gear mechanism 20, the clutch 4 and the brake 5 are disposed coaxially to a rotating shaft 2 of an engine 1 sequentially from the side near to the engine 1.

The correspondence relation of connection of respective rotating elements 11, 13, and 14 of the first planetary gear mechanism 10 and the engine 1, the first electric rotating machine MG1, the clutch 4, and the output gear 6 is common to the first embodiment. Further, the correspondence relation of connection of respective rotating elements 21, 23, and 24 of the second planetary gear mechanism 20 and the second electric rotating machine MG2, the clutch 4, the brake 5, and the output gear 6 is common to the first embodiment.

The first ring gear 13 is disposed on an inner peripheral surface of a rotary member 18, and the output gear 6 is disposed on an outer peripheral surface of the rotary member 18. The output gear 6 is disposed at the same position as the first ring gear 13 in an axial direction. The rotary member 18 is connected to the second carrier 24 via a coupling shaft 71. The coupling shaft 71 is disposed between the rotating shaft 2 of the engine 1 and a rotating shaft 44a of a rotor 44. The second carrier 24 is connected to the first ring gear 13 and the output gear 6 via the coupling shaft 71.

The clutch 4 is connected to the first carrier 14 via the rotating shaft 2 of the engine 1. The clutch 4 can connect the second ring gear 23 to the first carrier 14 in an engaged state and can disconnect the second ring gear 23 from the first carrier 14 in a released state. The brake 5 is disposed externally of the clutch 4 in a radial direction and can regulate the rotation of the second ring gear 23 by being engaged.

In the hybrid vehicle driving device 1-2 of the modification, the clutch 4 and the brake 5 are disposed to the end of the side opposite to the engine 1 side in the axial direction. As described above, since the engaging elements operated by hydraulic pressure or electric actuators are collectively disposed, an installation space can be reduced. When, for example, the clutch 4 and the brake 5 are of a hydraulic pressure type, since oil paths can be collectively disposed to a part of a T/A case, a processing cost can be reduced and a space for the oil paths can be reduced. When the clutch 4 and the brake 5 are of an electric type, since the sections where power cables are connected can be integrated, downsizing and cost reduction becomes possible.

### Second Modification of First Embodiment

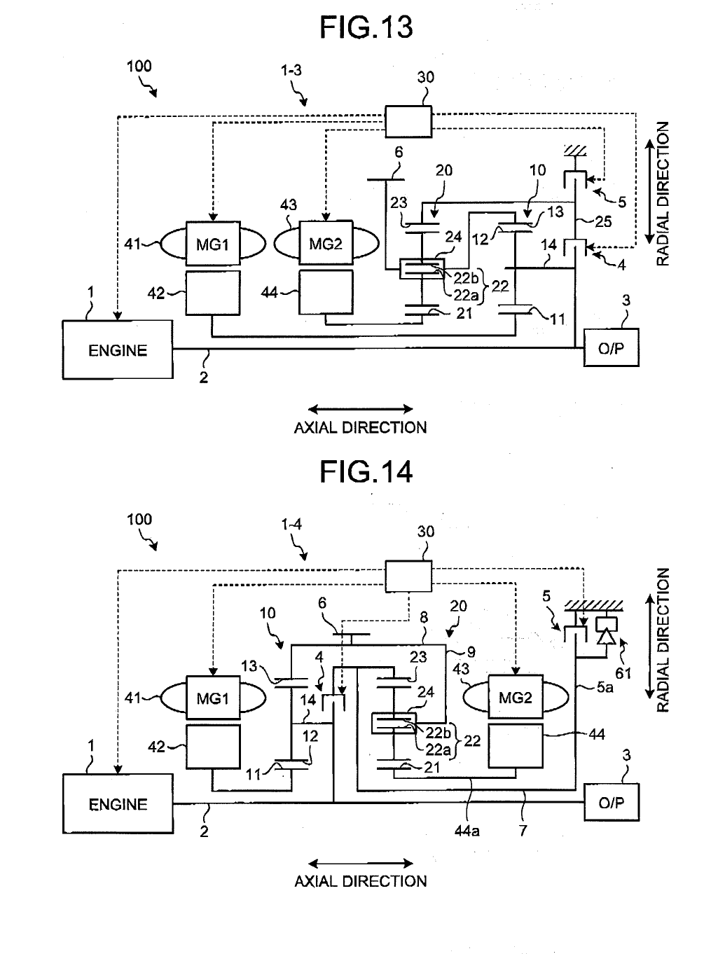

A second modification of the first embodiment will be explained. FIG. 13 is a skeleton view illustrating a main portion of a hybrid vehicle according to the second modification. A hybrid vehicle driving device 1-3 of the modification is different from the hybrid vehicle driving device 1-1 of the first embodiment in that a mechanical system of a first planetary gear mechanism 10, a second planetary gear mechanism 20, a clutch 4, and a brake 5 is collectively disposed on the side opposite to an engine side in an axial direction, and an electric system of a first electric rotating machine MG1 and a second electric rotating machine MG2 is collectively disposed on the engine side in the axial direction. The first electric rotating machine MG1, the second electric rotating machine MG2, the second planetary gear mechanism 20, and an output gear 6, the first planetary gear mechanism 10, the clutch 4, and the brake 5 are coaxially disposed sequentially to a rotating shaft 2 of the engine 1 from the side near to the engine 1.

The output gear 6 is connected to a second carrier 24 and disposed between the second electric rotating machine MG2 and the second planetary gear mechanism 20 in the axial direction. A first ring gear 13 is connected to the output gear 6 via the second carrier 24. A second ring gear 23 is connected with a projecting section 25. The projecting section 25 projects nearer to the side opposite to the engine 1 side than the first planetary gear mechanism 10 in the axial direction. The projecting section 25 is connected to the rotating shaft 2 of the engine 1 via the clutch 4 and connected to a vehicle body side via the brake 5. The clutch 4 can connect the second ring gear 23 to a first carrier 14 in an engaged state and can disconnect the second ring gear 23 from the first carrier 14 in a released state. The brake 5 is disposed externally of the clutch 4 in a radial direction and can regulate the rotation of the second ring gear 23 (the projecting section 25) by being engaged.

According to the modification, the electric parts such as the electric rotating machines MG1, MG2 and the like and the mechanical parts such as the planetary gear mechanisms 10 and 20, the clutch 4, the brake 5, and the like can be collectively disposed, respectively. As a result, the electric parts (the electrically driven parts) and the mechanical parts can be assembled in a different case, respectively in a factory so that the space and the weight of the parts to be transported can be reduced. The electric parts and the mechanical parts can be inspected and initially set at a stage of parts before the electric parts are combined with the mechanical parts. Further, since it becomes unnecessary to take the mechanical parts into a clean room in which the electric parts are mounted, a degree of cleaning can be optionally set to each of the electric parts and the mechanical parts. Thus, there is an advantage that the mechanical parts need not be cleaned at an unnecessarily high degree of cleaning.

Although FIG. 13 illustrates the first electric rotating machine MG1 and the second electric rotating machine MG2 in the same size, an actual size of any one of them, for example, the size of the second electric rotating machine MG2 becomes larger than that of the first electric rotating machine MG1. In the case, when the first electric rotating machine MG1 is disposed in a space internally of a stator 43 of the second electric rotating machine MG2 in a radial direction and configured as a nested structure, the hybrid vehicle driving device 1-3 can be downsized by reducing a space in the axial direction.

The order of disposition of the first electric rotating machine MG1, the second electric rotating machine MG2, the first planetary gear mechanism 10, the second planetary gear mechanism 20, the clutch 4, and the brake 5 is not restricted to those exemplified in the first embodiment and the respective modifications.

### Second Embodiment

A second embodiment will be explained referring to FIG. 14 to FIG. 16. In the second embodiment, the components having the same functions as those of the components explained in the first embodiment are denoted by the same reference numerals and a duplicate explanation will be omitted. FIG. 14 to FIG. 16 are skeleton views illustrating a main portion of the hybrid vehicle according to the second embodiment, respectively.

FIG. 14 is a skeleton view illustrating the main portion of the hybrid vehicle mounted with a hybrid vehicle driving device 1-4 that further includes a one way clutch 61 disposed to the hybrid vehicle driving device 1-1 (FIG. 1) according to the first embodiment. The one way clutch 61 is disposed to the side that is opposite to an engine 1 side and nearer to a brake 5 in parallel with the brake 5. The one way clutch 61 can allows the rotation of a second ring gear 23 only in a direction and regulate the rotation thereof in the opposite direction. The second ring gear 23 is connected to a vehicle body side, for example, to a T/A case via the one way clutch 61.

The one way clutch 61 allows the rotation of the second ring gear 23 in a positive direction and regulates the rotation thereof in a negative direction. With the operation, an EV-1 mode (refer to FIG. 3) can be realized without engaging the brake 5. Specifically, when a second electric rotating machine MG2 is caused to output negative torque and rotated negatively in the state that a clutch 4 and the brake 5 are released, the one way clutch 61 regulates the rotation of the second ring gear 23 in the negative direction. With the operation, likewise the EV-1 mode in which the brake 5 is engaged, a second carrier 24 is rotated positively by the torque of the second electric rotating machine MG2, and the hybrid vehicle 100 can be caused to travel forward.

At the time of start in the EV-1 mode, it becomes unnecessary to engage the brake 5. Thus, when an actuator of the brake 5 is configured as a hydraulic pressure type, an electric oil pump need not operate in a stopping state of a vehicle and the like. Thus, a control is simplified and the energy necessary to drive the electric oil pump can be reduced.

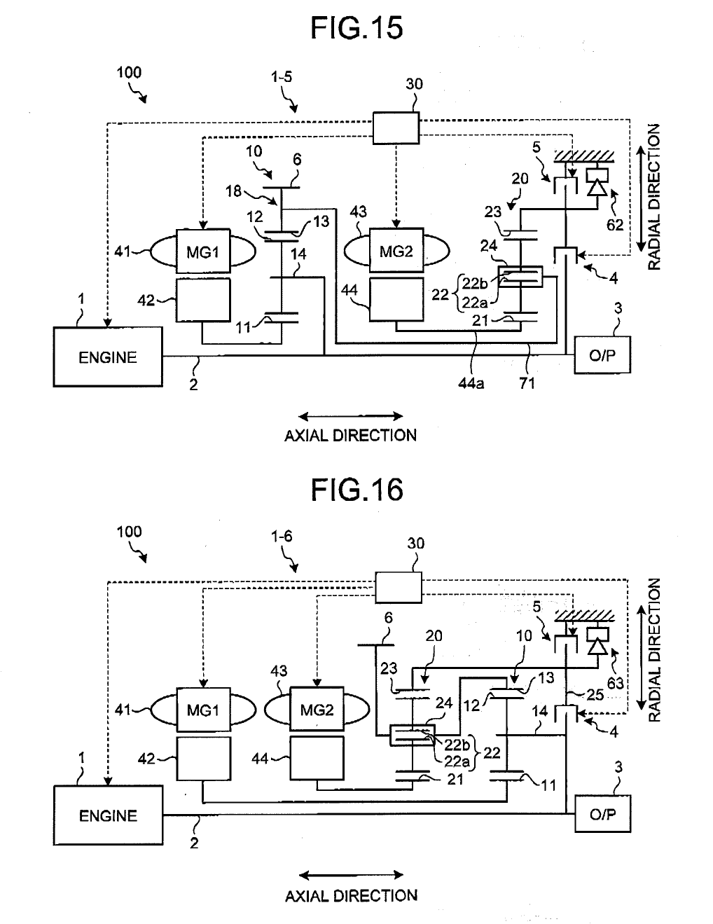

FIG. 15 is a skeleton view illustrating the main portion of the hybrid vehicle mounted with a hybrid vehicle driving device 1-5 that further includes a one way clutch 62 disposed to the hybrid vehicle driving device 1-2 (FIG. 12) according to the first modification of the first embodiment. The one way clutch 62 is disposed to the side that is opposite to the engine 1 side and nearer to the brake 5 in parallel with the brake 5. Likewise the one way clutch 61, the one way clutch 62 allows the rotation of a second ring gear in a positive direction and regulates the rotation thereof in a negative direction and can achieve an effect similar to that of the one way clutch 61.

FIG. 16 is a skeleton view illustrating the main portion of the hybrid vehicle mounted with a hybrid vehicle driving device 1-6 that further includes a one way clutch 63 disposed to the hybrid vehicle driving device 1-3 (FIG. 13) according to the second modification of the first embodiment. The one way clutch 63 is disposed to the side that is opposite to the engine 1 side and nearer to the brake 5 in parallel with the brake 5. Likewise the one way clutch 61, the one way clutch 63 allows the rotation of the second ring gear 23 in a positive direction and regulates the rotation thereof in a negative direction and can realize an effect similar to that of the one way clutch 61.

The contents disclosed in the respective embodiments and the modifications can be embodied by being appropriately combined.

### REFERENCE SIGNS LIST

1-1, 1-2, 1-3, 1-4, 1-5, 1-6 hybrid vehicle driving device
1 engine
2 rotating shaft
4 clutch
5 brake
10 first planetary gear mechanism
11 first sun gear
12 first pinion gear
13 first ring gear
14 first carrier
20, 50 second planetary gear mechanism
21, 51 second sun gear
22, 52 second pinion gear
23, 53 second ring gear
24, 54 second carrier
100 hybrid vehicle
MG1 first electric rotating machine
MG2 second electric rotating machine

1. A hybrid vehicle driving device comprising:
a first planetary gear mechanism;
a second planetary gear mechanism;
a clutch configured to connect and disconnect a carrier of the first planetary gear mechanism to and from a ring gear of the second planetary gear mechanism; and
a brake configured to regulate a rotation of the ring gear of the second planetary gear mechanism by being engaged, wherein
the second planetary gear mechanism is of a double pinion type,
a sun gear of the first planetary gear mechanism is connected to a first electric rotating machine, a carrier thereof is connected to an engine, and a ring gear thereof is connected to a driving wheel, respectively.

2. The hybrid vehicle driving device according to claim 1, wherein
a traveling by a mode 2 is realized by engaging the clutch and the brake, respectively.

3. The hybrid vehicle driving device according to claim 1, wherein
an order of disposition of respective rotating elements of the first planetary gear mechanism and the second planetary gear mechanism in an alignment chart at the time the clutch is engaged and the brake is released is in the order of the sun gear of the first planetary gear mechanism, the sun gear of the second planetary gear mechanism, the carrier of the first planetary gear mechanism and the ring gear of the second planetary gear mechanism, and the ring gear of the first planetary gear mechanism and the carrier of the second planetary gear mechanism.

4. The hybrid vehicle driving device according to claim 1, wherein
in a hybrid traveling for causing a hybrid vehicle to travel using at least the engine as a power source, at least two modes of a mode 3 for releasing the clutch and engaging the brake, a mode 4 for engaging the clutch and releasing the brake, and a mode 5 for releasing the clutch
and the brake can be selectively realized.

5. The hybrid vehicle driving device according to claim 1, wherein
a traveling by a mode 1 is realized by releasing the clutch and engaging the brake.

6. The hybrid vehicle driving device according to claim 1, wherein
the first electric rotating machine, the first planetary gear mechanism, the clutch, the second planetary gear mechanism, the second electric rotating machine, and the brake are sequentially disposed coaxially to a rotating shaft of the engine from the side near to the engine.

7. The hybrid vehicle driving device according to claim 1, wherein
the first electric rotating machine, the first planetary gear mechanism, the second electric rotating machine, the second planetary gear mechanism, the clutch, and the brake are sequentially disposed coaxially to a rotating shaft of the engine from the side near to the engine.

8. The hybrid vehicle driving device according to claim 1, wherein
the first electric rotating machine, the second electric rotating machine, the second planetary gear mechanism, the first planetary gear mechanism, the clutch, and the brake are sequentially disposed coaxially to a rotating shaft of the engine from side near to the engine.

9. The hybrid vehicle driving device according to claim 1, further comprising:
a one way clutch configured to allow, when the rotating direction of the carrier of the second planetary gear mechanism at the time the hybrid vehicle travels forward is assumed a positive direction, the rotation of the ring gear of the second planetary gear mechanism in the
positive direction, and regulate the rotation thereof in the direction opposite to the positive direction.

10. The hybrid vehicle driving device according to claim 2, wherein
an order of disposition of respective rotating elements of the first planetary gear mechanism and the second planetary gear mechanism in an alignment chart at the time the clutch is engaged and the brake is released is in the order of the sun gear of the first planetary gear mechanism, the sun gear of the second planetary gear mechanism, the carrier of the first planetary gear mechanism and the ring gear of the second planetary gear mechanism, and the ring gear of the first planetary gear mechanism and the carrier of the second planetary gear mechanism.

11. The hybrid vehicle driving device according to claim 2, wherein
in a hybrid traveling for causing a hybrid vehicle to travel using at least the engine as a power source, at least two modes of a mode 3 for releasing the clutch and engaging the brake, a mode 4 for engaging the clutch and releasing the brake, and a mode 5 for releasing the clutch and the brake can be selectively realized.

12. The hybrid vehicle driving device according to claim 2, wherein
a traveling by a mode 1 is realized by releasing the clutch and engaging the brake.
